(19) United States
(12) Patent Application Publication
(10) Pub. No.: US 2008/0135163 A1
(43) Pub. Date: Jun. 12, 2008

(54) TRANSFER PRODUCT METHOD

(76) Inventor: Michael S. Farmer, (US)

Correspondence Address: MARK BROWN, 4700 BELLEVIEW SUITE 210, KANSAS CITY, MO, 64112, US

(21) Appl. No.: 12/020,272

(22) Filed: Jan. 25, 2008

Related U.S. Application Data
(62) Division of application No. 10/982,464, filed on Nov. 5, 2004, now abandoned.

(51) Int. Cl. B44C 1/165

(52) U.S. Cl. 156/240

(57) ABSTRACT

A transfer decal retail product unit includes a transfer decal assembly, which can optionally be mounted on a display card. The assembly includes a liner comprising a material that contrasts visually with a graphic material releasably mounted thereon. An optional clear, transparent mask is releasably mounted on the graphic material and is adapted for removal after installation. The visual contrast between the liner and the graphic material facilitates point-of-purchase sales by attracting customers.

### CROSS-REFERENCE TO RELATED APPLICATIONS

This application is a divisional of Ser. No. 10/892,464 filed Nov. 5, 2004, now abandoned, which is incorporated herein by reference.

### BACKGROUND OF THE INVENTION

1. Field of the Invention

The present invention relates generally to transfer products, and in particular to a decal or other transfer product with a contrasting backing for high visibility, particularly in point-of-purchase displays.

2. Discussion of the Related Art

Decals comprise a popular class of ornamentation and graphical communication products. Various graphics including text and designs are commonly printed on transferable media. The graphics can thus be applied to various application surfaces. For example, decorative graphics are commonly applied to the windshield and window glass of vehicles. Other common applications of transfer decals include vehicle body parts, building windows, lockers, boats, aircraft, equipment, machinery and various other objects comprising a wide range of materials with varying degrees of hardness and softness.

The graphics printed on such transfer decals also encompass a wide range of subject matter. For example, vehicle-mounted decals enable people applying same to publicize their associations with or loyalties to particular institutions, such as colleges. Graphical displays can be informative, instructional and/or entertaining. They can incorporate warnings and instructions, particularly when applied to hazardous equipment and machinery.

A significant portion of the market for transfer decals and other transfer products is serviced by retail point-of-purchase sales. Most transfer decals marketed to individual consumers tend to be relatively inexpensive and are considered “impulse purchases” by retailers. Accordingly, point-of-purchase displays of such products are typically designed to attract consumer attention and motivate impulse buying. Therefore, product visibility is an objective in connection with such retail displays. However, a common problem among existing transfer decal products relates to a lack of contrast between the actual graphics and the backing materials on which they are mounted. For example, white graphics, which are popular because they are highly visible on tinted vehicle glass, visually blend in with light-colored liner materials. In retail displays, consumers may encounter difficulty in discerning such graphics and other products. The resulting confusion and lack of visual contrast can hurt sales.

In addition to decals and graphics, the visually contrasting appearance of the present invention has other applications, such as non-skid material, which can be die cut to form particular shapes and mounted on contrasting-color liner materials for enhanced visibility.

Heretofore there have not been available a transfer retail product unit with the advantages and features of the present invention.

### BRIEF DESCRIPTION OF THE INVENTION

In the practice of one aspect of the present invention, a transfer decal retail product unit includes a multi-layer decal assembly comprising a liner with an appearance characteristic for visually contrasting with a graphic material layer, which can optionally be covered by a clear mask layer adapted to transfer the graphic material to an application surface. The multi-layer assembly can optionally be mounted on a display card, which can be preprinted with additional textual and ornamental graphics.

### BRIEF DESCRIPTION OF THE DRAWINGS

The drawings constitute a part of this specification and include exemplary embodiments of the present invention and illustrate various objects and features thereof.

FIG. 1 is a perspective view of a transfer decal retail product unit embodying an aspect of the present invention.

FIG. 2 is a perspective view, showing a transfer decal assembly prior to application.

FIG. 3 is a fragmentary cross-sectional view.

FIG. 4 is a cross-sectional view showing a backing liner being removed.

FIG. 5 is a cross-sectional view showing the transfer decal assembly positioned over an application surface for application thereto.

FIG. 6 is a cross-sectional view showing the graphic applied to the application surface and the mask layer being removed.

FIG. 7 is a cross-sectional view of the final configuration, with the graphic applied to the application surface.

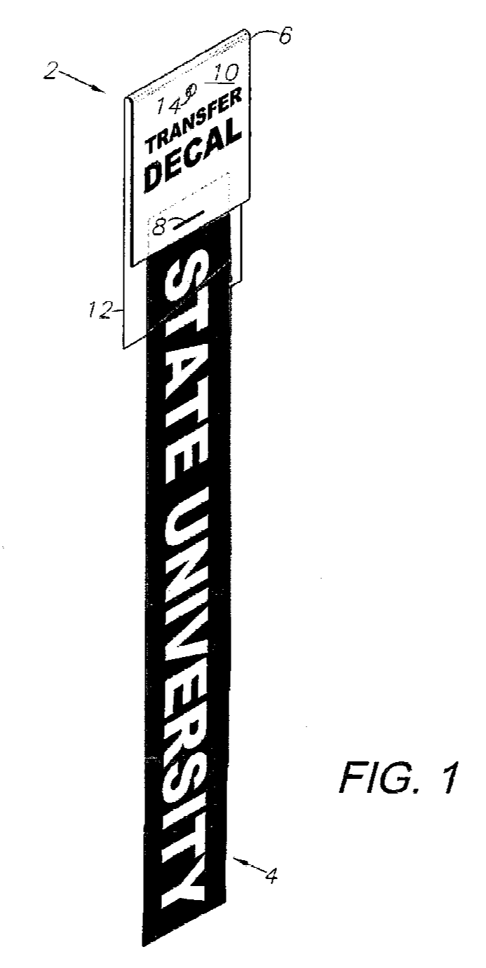

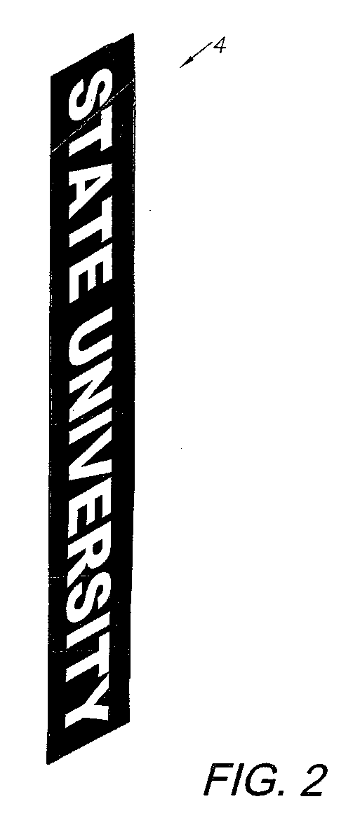

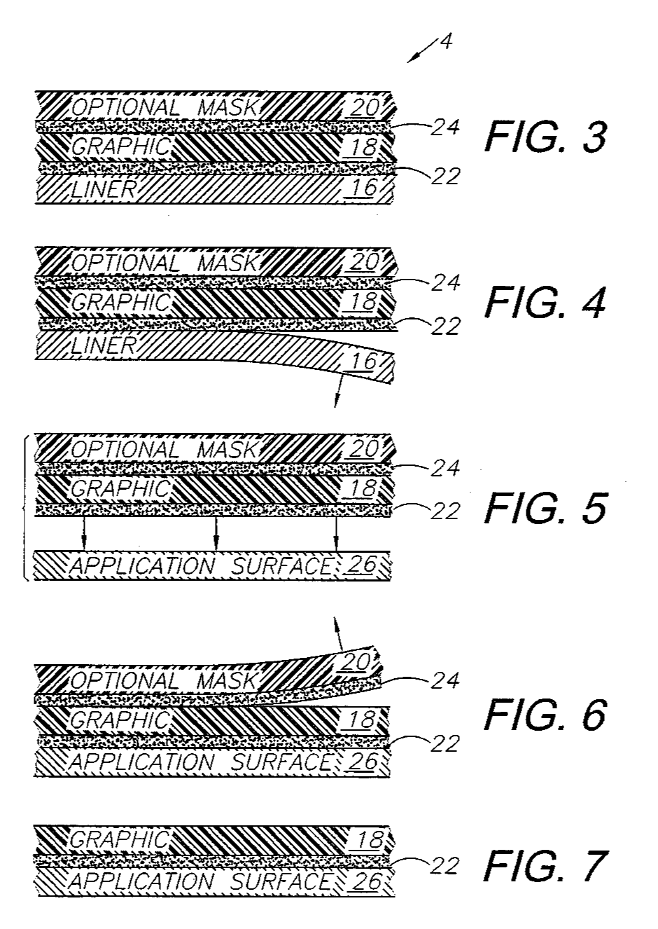

### DETAILED DESCRIPTION OF THE INVENTION

As required, detailed embodiments and/or aspects of the present invention are disclosed herein: however, it is to be understood that the disclosed embodiments/aspects are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to the drawings in more detail, the reference numeral 2 generally designates a transfer decal retail product embodying an aspect of the present invention. The unit 2 generally includes a transfer decal assembly 4 and an optional display card 6. The display card 6 is folded double to capture one end of the transfer decal assembly 4, and is secured thereto and to itself by a staple 8, or other suitable fastener, such as a brad, rivet, adhesive, etc. The card 6 thus forms front and back panels 10, 12, which can be of different lengths, as shown. The outer surfaces of the card panels 10, 12 can be preprinted with promotional and instructional subject matter. An aperture 14 extends through the card panels 10, 12 and can be centered near the top of the card 6 whereby the product unit 2 can be suspended on a wire hook or peg of the type commonly used in retail point-of-purchase displays.

The transfer decal assembly 4 includes a liner 16, graphic material 18 and a mask 20. The liner 16 can comprise a suitable material such as plastic, synthetic material or paper with a suitable release agent such as silicon or wax. A suitable liner-graphic adhesive 22 releasably secures the graphic material 18 to the liner 16. A shown in FIG. 4, the liner 16 is adapted for peeling away from the graphic 18 as a first step in the process of applying the decal.

The graphic material 18 can comprise a suitable vinyl, polyester or other material, and can include various visual effects such as chrome, phosphorescent materials or special coatings. The graphic material 18 can be precut to form visual graphic patterns, such as letters in a textual graphic and/or various designs and logos. Therefore, the graphic material 18 can comprise multiple, discrete elements, e.g. separate letters forming a word or words. The graphic material 18 elements can optionally be maintained in position with the optional mask 20 prior to final installation. For example, graphic material 18 comprising multiple letters, characters and/or designs can be maintained with proper spacing therebetween by the optional mask 20. Alternatively, the graphic material 18 can comprise a single design or other component, and thus be adapted for direct application without any requirement of maintaining spacing between multiple characters, etc. With such a unitary graphic component, the mask 20 is not necessary for maintaining spacing and can therefore be omitted.

As shown in FIG. 5, a suitable graphic-mask adhesive 24 can releasably secure the graphic material 18 to the optional mask 20 prior to installation on an application surface 26. The liner-graphic adhesive 22, which clings to the back or underside of the graphic material 18 after the liner 16 is peeled away (FIG. 4), securely affixes the graphic material 18 to the application surface 26. The adhesive 22 can be chosen from among various commercially available products, which are compatible with the surface energy of the application surface 26. With the graphic material 18 adhered to the application surface 26 (FIG. 6), the mask 20, if utilized, can be peeled away, leaving the graphic material 18 secured to the application surface 26 in a final configuration, as shown in FIG. 7. The liner-graphic adhesive 22 preferably bonds to the application surface 26 more strongly then the graphic-mask adhesive 24 whereby the graphic material 18 remains securely affixed to the application surface 26 while peeling away the mask 20 (FIG. 6). Alternatively, if the transfer product 2 does not include a mask, installation is complete when the graphic material 18 is affixed to the application surface 26.

The liner 16 preferably contrasts visually with the graphic material 18. For example, the contrast can be white on black. The liner 16 can comprise black polyester or suitable paper with a black coating, or some other suitable dark-colored surface with a release coating. Other contrasts can include color, patterns, materials and any other suitable contrasting visual effects. Such visual contrast facilitates customer attraction in connection with point-of-purchase retail displays. The contrast of the liner 16 tends to emphasize the finished appearance of the graphic material 18, thus enabling the customers to visualize the aesthetic effect of the final installation. For example, applying the graphic material 18 to the tinted windshield or windows of a vehicle can be aesthetically simulated in a retail, point-of-purchase setting by mounting white graphic material 18 on a black liner 16 for enhancing the visual contrast therebetween, thus enabling prospective customers to “visualize” the finished result. The mask 20 preferably comprises a clear material, such as clear vinyl, polyolefin, polyester, polystyrene, etc., whereby the graphic material 18 and the contrasting liner 16 are visible therethrough prior to installation.

It will be appreciated that while certain exemplary aspects and embodiments of the invention are shown and described herein, numerous other aspects and embodiments are within the scope of the invention, which is not to be limited to the specific examples shown and described.

Having thus described the invention, what is claimed as new and desired to be secured by Letters Patent is:

1. A method of transferring a graphic material from a transfer decal assembly to an application surface, comprising the steps of:
providing a transfer assembly having a liner, the graphic material and a mask;
providing the graphic material with front and back surfaces;
securing the graphic material to the liner with a suitable liner-graphic adhesive;
securing the mask to the graphic material with a suitable graphic-mask adhesive;
providing the liner and the graphical material with a visual contrast;
mounting the transfer assembly on a card;
displaying the mounted transfer assembly;
separating the transfer assembly from the card;
peeling away the graphic material from the liner;
transferring the graphic material to the application surface and adhering to both the application surface and the graphic material;
said liner-graphic adhesive bonding said graphic material to the application surface more strongly than to the mask whereby the graphic material remains securely affixed to the application surface while peeling away the mask; and peeling away the mask from the graphic material.
